(19) United States
(12) Patent Application Publication
(10) Pub. No.: US 2026/0350456 A1
(43) Pub. Date: Nov. 5, 2026

(54) QUANTUM COMPUTING DEVICE FOR PHYSICS INSPIRED EXTRAPOLATION AND ERROR MITIGATION BY RESTRICTED EVOLUTION AND METHOD THEREOF

(71) Applicant: LG ELECTRONICS INC., Seoul (KR)

(72) Inventors: Gaurav Saxena, Toronto (CA); Pablo Diez Valle, Madrid (SP); Thi Ha Kyaw, Burlington (CA); Jack Baker, Pickering (CA)

(73) Assignee: LG ELECTRONICS INC., Seoul (KR)

(21) Appl. No.: 19/659,731

(22) Filed: Apr. 27, 2026

Related U.S. Application Data
(60) Provisional application No. 63/795,000, filed on Apr. 25, 2025.

(51) Int. Cl. G06N 10/70; G06N 10/20

(52) U.S. Cl. CPC G06N 10/70; G06N 10/20

(57) ABSTRACT

An error mitigation method for a quantum computing device can receiving specification data defining a quantum circuit configuration. The method can generate updated configurations by applying different numbers of circuit foldings to the target circuit. These configurations are modified by replacing at least one gate with an implementable quantum gate selected based on a positive component of a generalized quasi-probabilistic decomposition, in which negative components can be excluded. The updated configurations are transmitted to the quantum hardware for execution. The method can then receive experimental expectation values corresponding to the different numbers of circuit foldings. Then, an error-mitigated expectation value is determined by applying an extrapolation between the experimental expectation values and the corresponding circuit folding numbers.

### CROSS-REFERENCE TO RELATED APPLICATIONS

This non-provisional application claims priority under 35 U.S.C. § 119 (e) to U.S. Provisional Application No. 63/795,000, filed on Apr. 25, 2025, the entirety of which is hereby expressly incorporated by reference into the present application. This application also incorporates by reference the entire disclosure of U.S. Pat. No. 12,572,839, filed on Jul. 31, 2024.

### BACKGROUND

### Field

The present disclosure relates to a quantum computing device and method for zero-noise estimation and error mitigation. Particularly, the method can perform physics-inspired extrapolation (PIE) to execute error mitigation by restricted evolution (EMRE) and hardware certification in the fields of quantum computing and artificial intelligence (AI).

### Discussion of the Related Art

Quantum computers represent a revolutionary leap forward in computing technology with their potential to solve complex problems exponentially faster than classical computers.

Unlike classical computers that use transistors to implement binary bits, which can be either 0 or 1, quantum computers use qubits. Qubits can exist in a superposition of states, allowing them to perform multiple calculations simultaneously and potentially tackle problems that are intractable by classical computers.

For example, quantum computers promise a quantum advantage in numerous applications, such as factoring, solving linear systems, quantum simulations, and quantum chemistry/material discovery.

However, the power of quantum computers comes with unique challenges, such as dealing with noise and decoherence. Quantum systems are inherently fragile and susceptible to various sources of noise and errors. These errors can arise from interactions with the environment, imperfections in physical hardware components, or limitations in control and measurement mechanisms.

For example, hybrid quantum computers that implement an architecture of a classical computer and a quantum computer working together to solve a problem, also referred to as noisy intermediate scale quantum (NISQ) computers, can execute algorithms that are often designed for short-depth quantum circuits having limited numbers of qubits and gates, e.g., variational quantum algorithms (VQAs) and in the form of a hybrid quantum-classical feedback loop.

However, even NISQ computers having short-depth quantum circuits are not fault tolerant, and the presence of noise and errors can limit their utility. For example, the result or expectation value output by a quantum computer may be so influenced by noise and errors that its output becomes unreliable or unusable.

In order to extend the reach of near-term quantum computers and NISQ computers, error mitigation techniques are used, such as deploying a mixture of quantum sampling and classical post-processing techniques.

However, many existing error mitigation techniques require either exponential copies of quantum states or an exponential number of sampling measurements, with respect to the amount of noise present in the quantum hardware. Thus, such techniques become impractical with an increase in the system size and have exponential runtime (e.g., O(2\hat{ }n)).

For example, zero-noise extrapolation (ZNE) and theoretical probabilistic error cancelation (PEC) are two types of algorithms that can be used for dealing with errors in quantum computers. While theoretical PEC can give an unbiased estimate of the expectation value, it does so at the cost of an exponential sampling overhead (e.g., exponential runtime).

On the other hand, standard ZNE generates an estimate by scaling the quantum circuit several times at different noise levels and extrapolating the results to a zero-noise limit. However, standard ZNE relies on heuristic or randomly chosen extrapolation functions (e.g., arbitrary polynomial or empirical exponential fits) that lack a theoretical physical foundation. Because it relies on guessing the shape of the decay curve, standard ZNE suffers from a large standard deviation (high variance) and produces statistically unstable estimates.

Furthermore, in practical physical quantum computing environments, identifying the optimal error mitigation parameters often requires extensively characterizing the underlying hardware noise beforehand. This noise characterization is highly resource intensive and is often impractical to deploy on actual physical hardware where the true operational noise profile acts as an unpredictable black box.

Thus, there exists a need for a quantum computing device and method capable of efficiently mitigating hardware errors without requiring prior noise characterization or arbitrary heuristic curve fitting.

Further, a need exists for a deterministic, physics-derived extrapolation technique to exponentially reduce data requirements and statistical variance.

Additionally, a need exists for a method capable of extracting physically meaningful operational metrics during the extrapolation process to simultaneously certify the fidelity of the physical quantum hardware.

### SUMMARY OF THE DISCLOSURE

The present disclosure has been made in view of the above problems, and it is an object of the present disclosure to provide a quantum computing device and method capable of efficiently mitigating computational errors without requiring prior characterization of unknown hardware noise. Further, the present disclosure provides deterministic, physics inspired extrapolation (PIE) to execute error mitigation by restricted evolution (EMRE) and hardware certification in the fields of quantum computing and artificial intelligence (AI).

An object of the present disclosure is to provide a method for mitigating error in a quantum computing device that includes receiving a quantum circuit configuration including a plurality of quantum gates, generating a plurality of updated quantum circuit configurations by applying different numbers of circuit foldings to the quantum circuit configuration, in which at least one gate in the plurality of updated quantum circuit configurations is replaced with at least one implementable quantum gate selected from among a set of implementable quantum gates based on a generalized quasi-probabilistic decomposition including a positive component, where a negative component of the generalized quasi-probabilistic decomposition is excluded, executing the plurality of updated quantum circuit configurations, by the quantum computing device, to generate a plurality of experimental expectation values corresponding to the different numbers of circuit foldings, and calculating an error mitigated expectation value by applying a linear extrapolation between a logarithm of the plurality of experimental expectation values and the corresponding different numbers of circuit foldings.

Another object of the present disclosure is to provide a method that can include receiving quantum circuit specification data defining a quantum circuit configuration, the quantum circuit configuration specifying a plurality of quantum gates, generating a plurality of updated quantum circuit configurations by applying different numbers of circuit foldings to the quantum circuit configuration, modifying the plurality of updated quantum circuit configurations by replacing at least one gate with at least one implementable quantum gate selected from among a set of implementable quantum gates based on a positive component of a generalized quasi-probabilistic decomposition, in which a negative component of the generalized quasi-probabilistic decomposition is excluded, transmitting the plurality of updated quantum circuit configurations to the quantum computing device for execution, receiving a plurality of experimental expectation values from the quantum computing device based on the execution of the plurality of updated quantum circuit configurations, the plurality of experimental expectation values corresponding to the different numbers of circuit foldings, and determining an error-mitigated expectation value based on applying an extrapolation between the plurality of experimental expectation values and the corresponding different numbers of circuit foldings.

It is another object of the present disclosure to provide a method, in which the determining the error-mitigated expectation value based on applying the extrapolation includes calculating the error-mitigated expectation value by applying a linear extrapolation between a logarithm of the plurality of experimental expectation values and the corresponding different numbers of circuit foldings.

Yet another object of the present disclosure is to provide a method that further includes extracting a slope of the linear extrapolation, and outputting a hardware certification metric based on the slope, in which the hardware certification metric indicates a maximum relative entropy between a physical implementation of the quantum circuit configuration and an ideal target circuit.

An object of the present disclosure is to provide a method, in which the applying the different numbers of circuit foldings includes substituting at least one logical gate of the quantum circuit configuration with an identity-equivalent gate sequence configured to amplify physical hardware noise without altering a target logical operation of the quantum circuit configuration.

Another object of the present disclosure is to provide a method, in which the modifying the plurality of updated quantum circuit configurations includes stochastically inserting the at least one implementable quantum gate into the plurality of updated quantum circuit configurations based on a strictly positive probability distribution derived from the positive component of the generalized quasi-probabilistic decomposition.

An object of the present disclosure is to provide a method, in which the set of implementable quantum gates includes natively executable Pauli gates.

Yet another object of the present disclosure is to provide a method that further includes retaining a predefined subset of the negative component of the generalized quasi-probabilistic decomposition based on a predefined threshold, and modifying the plurality of updated quantum circuit configurations further based on the predefined subset of the negative component to dynamically tune a balance between target accuracy and computational variance.

An object of the present disclosure is to provide a method, in which the generating the plurality of updated quantum circuit configurations and the determining the error-mitigated expectation value are performed without determining a measured noise representation of the quantum computing device via a physical noise characterization protocol.

Another object of the present disclosure is to provide a method that further includes predicting, by a trained machine learning model, an optimal target gate location for applying the circuit foldings based on historical calibration data of the quantum computing device.

An object of the present disclosure is to provide a method, in which the receiving the plurality of experimental expectation values includes receiving a plurality of raw measurement outcomes from the quantum computing device generated via Monte Carlo sampling over a plurality of iterations and averaging the plurality of raw measurement outcomes to calculate a distinct noisy expectation value corresponding to each respective circuit folding number.

Another object of the present disclosure is to provide a method that further includes utilizing the error-mitigated expectation value in a downstream hybrid quantum-classical algorithm to optimize a physical parameter of a device or to evaluate a gradient for training a generative artificial intelligence model.

Another object of the present disclosure is to provide an artificial intelligence (AI) device including a memory configured to store a plurality of experimental expectation values, and a controller configured to receive quantum circuit specification data defining a quantum circuit configuration, the quantum circuit configuration specifying a plurality of quantum gates, generate a plurality of updated quantum circuit configurations by applying different numbers of circuit foldings to the quantum circuit configuration, modify the plurality of updated quantum circuit configurations by replacing at least one gate with at least one implementable quantum gate selected from among a set of implementable quantum gates based on a positive component of a generalized quasi-probabilistic decomposition, in which a negative component of the generalized quasi-probabilistic decomposition is excluded, transmit the plurality of updated quantum circuit configurations to a quantum computing device for execution, receive the plurality of experimental expectation values from the quantum computing device based on the execution of the plurality of updated quantum circuit configurations, the plurality of experimental expectation values corresponding to the different numbers of circuit foldings, and determine an error-mitigated expectation value based on applying an extrapolation between the plurality of experimental expectation values and the corresponding different numbers of circuit foldings.

An object of the present disclosure is to provide a non-transitory computer readable medium storing computer-executable instructions that when executed by one or more processors, cause the one or more processors to perform operations of receiving quantum circuit specification data defining a quantum circuit configuration, the quantum circuit configuration specifying a plurality of quantum gates, generating a plurality of updated quantum circuit configurations by applying different numbers of circuit foldings to the quantum circuit configuration, modifying the plurality of updated quantum circuit configurations by replacing at least one gate with at least one implementable quantum gate selected from among a set of implementable quantum gates based on a positive component of a generalized quasi-probabilistic decomposition, in which a negative component of the generalized quasi-probabilistic decomposition is excluded, transmitting the plurality of updated quantum circuit configurations to the quantum computing device for execution, receiving a plurality of experimental expectation values from the quantum computing device based on the execution of the plurality of updated quantum circuit configurations, the plurality of experimental expectation values corresponding to the different numbers of circuit foldings, and determining an error-mitigated expectation value based on applying an extrapolation between the plurality of experimental expectation values and the corresponding different numbers of circuit foldings.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates a hybrid quantum-classical computer architecture according to an embodiment of the present disclosure.

FIG. 4 illustrates an example flow chart for a method of implementing physics-inspired extrapolation (PIE) and mitigating error in a quantum computing device, according to an embodiment of the present disclosure.

FIG. 5 illustrates a flowchart of a method for implementing physics-inspired extrapolation (PIE) with mitigating error and incorporating stochastic scheduling and data aggregation, according to an embodiment of the present disclosure.

FIG. 6 illustrates a block diagram of a hybrid quantum-classical system for executing physics-inspired extrapolation and error mitigation, according to an embodiment of the present disclosure.

FIG. 7, including parts a), b) and c), illustrates diagrams and data plots representing noise amplification, exponential fitting, and log-linear extrapolation, according to an embodiment of the present disclosure.

FIG. 8, including parts a), b) and c), illustrates evaluation results comparing a physics-inspired extrapolation method against related extrapolation techniques executed on physical quantum hardware, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through the following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Also, the term device used herein can refer to a single device or a group of multiple devices that are connected together via wired connections or wireless connections.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Quantum computing is a field of computing that utilizes the principles of quantum mechanics to process and store information. At its core are quantum bits, or qubits, which can exist in multiple states simultaneously due to superposition. Unlike classical bits, which are strictly either 0 or 1, qubits can represent 0, 1, or any combination of both at the same time. This property allows quantum computers to perform numerous calculations simultaneously, potentially solving complex problems exponentially faster than classical computers.

Quantum computing can take advantage of any two-state quantum system. For example, qubits can be physically realized based on the spin of an electron, photon polarization, superconducting circuits, nuclear spin, trapped ions, defects in diamond crystals, and the like. Quantum computing also leverages entanglement, where the states of multiple qubits are interconnected, offering powerful computational capabilities (e.g., the computational state space scales exponentially by 2ⁿ, where n is the number of qubits).

Artificial intelligence (AI) refers to the field of studying and developing methodologies for creating artificial intelligence. Machine learning, a subset of AI, refers to the field of defining various issues dealt with in AI and studying methodologies for solving them. Machine learning is generally defined as an algorithm that enhances the performance of a certain task through steady experience or training data associated with that task.

An artificial neural network (ANN) is a model used in machine learning that represents a problem-solving architecture composed of artificial neurons (nodes) that form a network via synaptic connections. An artificial neural network can be defined by a connection pattern between neurons in different layers, a training process for updating model parameters, and an activation function for generating an output value.

In addition, a hybrid quantum-classical computer architecture can incorporate a neural network by combining the strengths of both classical and quantum computers to solve complex problems. The quantum component of the architecture can include qubits employed to execute specific quantum computations suited for tasks like quantum simulations, optimization, quantum chemistry, or material discovery (e.g., utilizing a QPU). The classical component of the architecture can include one or more CPUs or GPUs configured to handle tasks that are not well-suited for quantum processing, such as managing the overall computation, handling input/output, and running classical algorithms. Further, a neural network can be used to translate data and tasks between the CPU and the QPU, optimize the system, solve for parameters, and adjust parameters (e.g., minimizing a cost function).

An artificial neural network can include an input layer, an output layer, and optionally one or more hidden layers. Each layer includes one or more neurons, and synapses link the neurons together. In the artificial neural network, each neuron can output a function value of the activation function based on input signals, weights, and biases input through the synapses.

Model parameters refer to parameters determined through training and include synaptic connection weight values and neuronal biases. A hyperparameter refers to a parameter that is set in the machine learning algorithm prior to training, and includes variables such as a learning rate, a repetition number, a mini-batch size, and an initialization function.

The primary purpose of training an artificial neural network is to determine the model parameters that minimize a loss function. The loss function can be used as an index to determine optimal model parameters during the training process.

Machine learning can be broadly classified into supervised learning, unsupervised learning, and reinforcement learning, depending on the learning methodology.

Supervised learning can refer to a method of training an artificial neural network using labeled training data. The label represents the correct answer (or target result value) that the artificial neural network should learn to infer when the corresponding training data is input. Unsupervised learning refers to a method of training an artificial neural network using unlabeled data to find hidden structures or patterns. Reinforcement learning refers to a method in which an agent defined in a certain environment learns to select a behavior or sequence of behaviors that maximizes a cumulative reward in each state.

Machine learning models implemented as deep neural networks (DNNs), which include a plurality of hidden layers, are often referred to as deep learning models. In the following description, the term machine learning encompasses deep learning methodologies.

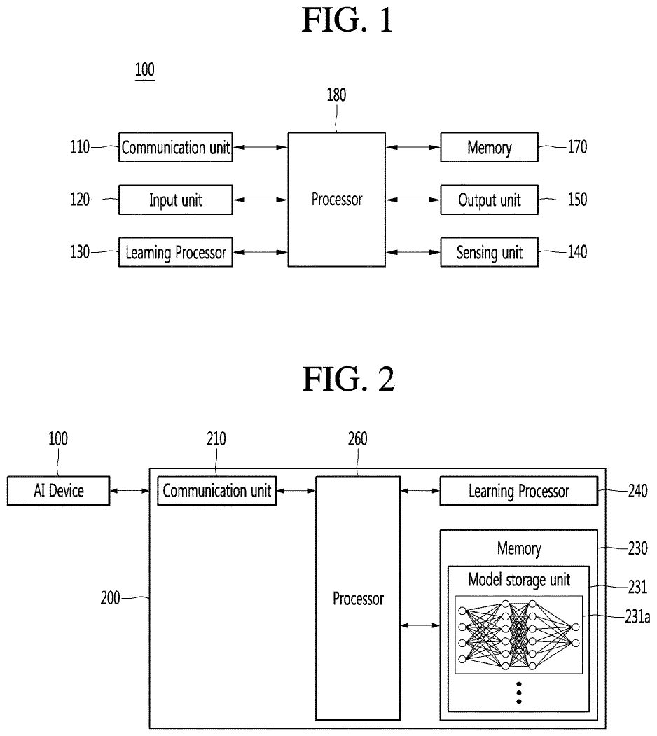

FIG. 1 illustrates an artificial intelligence (AI) device 100 which can be utilized as part of a hybrid quantum-classical computer architecture (e.g., executing the classical processing tasks), according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, digital signage, a robot, a vehicle, and the like. However, other variations are possible.

Referring to FIG. 1, the AI device 100 can include a communication unit 110 (e.g., a transceiver), an input unit 120 (e.g., a touchscreen, keyboard, mouse, microphone, etc.), a learning processor 130, a sensing unit 140 (e.g., one or more sensors or cameras), an output unit 150 (e.g., a display or speaker), a memory 170, and a processor 180 (e.g., a controller).

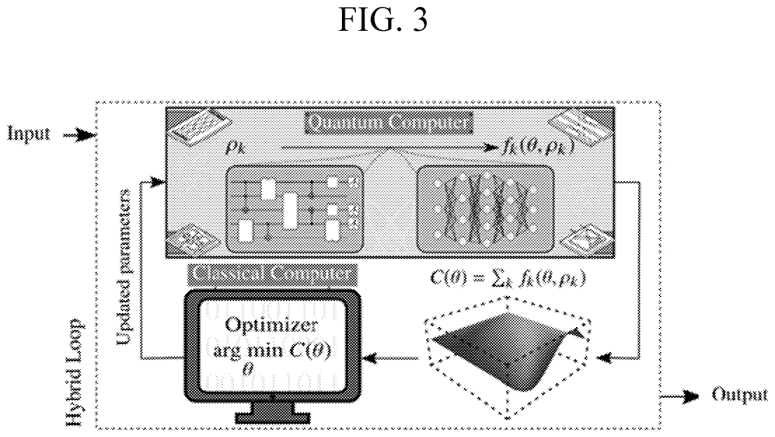

The communication unit 110 (e.g., communication interface or transceiver) can transmit and receive data to and from external devices such as other AI devices 100a to 100e and the AI server 200 (e.g., FIGS. 2 and 3) using wired/wireless communication technology. For example, the communication unit 110 can transmit and receive sensor information, user inputs, learning models, and control signals to and from external devices.

The communication technology utilized by the communication unit 110 can include GSM (Global System for Mobile communication), CDMA (Code Division Multi Access), LTE (Long Term Evolution), 5G, 6G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data. For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire training data for model learning and input data to be evaluated using a trained model. The input unit 120 can acquire raw input data. In this situation, the processor 180 or the learning processor 130 can extract an input feature by preprocessing the input data.

The learning processor 130 can train a model composed of an artificial neural network using the training data. The trained artificial neural network can be referred to as a learning model. The learning model can be used to infer a result value for new input data, and the inferred value can be used as a basis for determining a subsequent operation to perform.

For example, the learning processor 130 can perform AI processing tasks in conjunction with the learning processor 240 of the AI server 200.

In addition, the learning processor 130 can include memory integrated within or otherwise implemented in the AI device 100. Alternatively, the learning processor 130 can be implemented using the memory 170, an external memory directly connected to the AI device 100, or a memory held in a separate external device.

The sensing unit 140 can acquire internal information regarding the AI device 100, ambient environment information surrounding the AI device 100, and user information by utilizing various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

In addition, the output unit 150 can include a display unit for outputting visual information, a speaker for outputting auditory information, and a haptic module for outputting haptic feedback.

The memory 170 can store data that supports the various functions of the AI device 100. For example, the memory 170 can store input data acquired by the input unit 120, training data, trained models, learning histories, and the like.

The processor 180 can determine at least one executable operation of the AI device 100 based on information evaluated or generated using a data analysis algorithm or a machine learning algorithm. The processor 180 can control the components of the AI device 100 to execute the determined operation. For example, the processor 180 can evaluate logic rules to solve for parameters that are subsequently fed into a quantum circuit (e.g., determining rotation angles for physical quantum gates).

To this end, the processor 180 can request, search, receive, or utilize data from the learning processor 130 or the memory 170. The processor 180 can control the components of the AI device 100 to execute the predicted operation or the operation determined to be optimal among the executable operations.

When connection to an external device is desired to perform the determined operation, the processor 180 can generate a control signal for controlling the external device and transmit the generated control signal to the external device.

The processor 180 can acquire information from user inputs and determine an appropriate response, recommended item, or action based on the acquired intent information.

The processor 180 can process the user input utilizing at least one of a speech-to-text (STT) engine for converting speech input into a text string or a natural language processing (NLP) engine for determining the intention of the natural language input.

At least one of the STT engine or the NLP engine can be configured as an artificial neural network trained via machine learning algorithms. The STT engine or the NLP engine can be trained by the learning processor 130, by the learning processor 240 of the AI server 200 (see FIG. 2), or via distributed processing between the two.

The processor 180 can control the components of the AI device 100 to drive an application program stored in the memory 170. Furthermore, the processor 180 can operate two or more components included in the AI device 100 in combination to drive the application program.

FIG. 2 illustrates an AI server 200 according to one embodiment. The AI server can implement one or more components or tasks related to the classical computing portion of a hybrid quantum-classical computer architecture.

Referring to FIG. 2, the AI server 200 can refer to a device that trains an artificial neural network using a machine learning algorithm or utilizes a previously trained artificial neural network. The AI server 200 can include a plurality of servers configured for distributed processing, or can be defined over a 5G network, 6G network, or other communications network. Also, the AI server 200 can be included as a partial configuration of the AI device 100 to perform AI processing collaboratively.

The AI server 200 can include a communication unit 210, a memory 230, a learning processor 240, a processor 260, and the like.

The communication unit 210 can transmit and receive data to and from an external device, such as the AI device 100.

The memory 230 can include a model storage unit 231. The model storage unit 231 can store a model being trained or a fully trained model (e.g., an artificial neural network 231a) generated by the learning processor 240.

The learning processor 240 can train the artificial neural network 231a using training data. The learning model can be utilized while mounted on the AI server 200, or it can be transmitted and utilized on an external device such as the AI device 100.

The learning model can be implemented in hardware, software, or a combination of hardware and software. If all or part of the learning model is implemented in software, the instructions constituting the model can be stored in the memory 230.

The processor 260 can infer result values for new input data using the learning model and can generate responses or control commands based on the inferred values.

FIG. 3 illustrates a hybrid quantum-classical computer architecture according to an embodiment of the present disclosure.

The hybrid quantum-classical computer architecture can include a Quantum Processing Unit (QPU) and a Classical Processing Unit (CPU) interfaced to leverage the distinct advantages of both computing paradigms. The QPU includes qubits capable of superposition and entanglement, designed for executing quantum algorithms and operations to tackle complex problems with exponential speed-ups. Because the qubits can represent multiple states simultaneously, the QPU is highly effective for quantum simulations.

Conversely, the CPU manages classical computations, data input/output, and overall system control. An interface layer facilitates communication between the quantum and classical components, translating high-level tasks into quantum operations (e.g., specific microwave or optical pulse instructions), and converting quantum readouts back into classical data.

This interface layer includes software, firmware, and protocols for optimizing performance and managing the hybrid workflow.

Quantum algorithms, such as variational quantum algorithms (VQA) and quantum chemistry simulations, can be run on the QPU to exploit quantum properties. Control software operating on the CPU oversees the hybrid system's operation, including managing error correction, noise mitigation protocols, and classical optimization routines required to update the quantum computation.

Because inherent noise and hardware errors significantly impact near-term quantum hardware, error correction and mitigation techniques can be integrated into the architecture. The hybrid architecture can also include an application layer providing user interface software, enabling interaction with the system to input problems, receive results, and analyze mitigated data.

In more detail, the classical computer can include an optimizer or optimization function configured to implement a cost function (or objective function). The cost function can be optimized using various techniques, such as gradient descent, though embodiments are not limited thereto. The optimizer can utilize various hyperparameters, such as step size and iteration counts, to dictate how the system converges on a minimum.

This type of hybrid quantum-classical computer architecture can be referred to as a near-term quantum computer, a noisy intermediate-scale quantum (NISQ) computer, or a NISQ device.

NISQ algorithms can be designed for short-depth quantum circuits with limited numbers of qubits and gates (e.g., VQAs), as deeper circuits may quickly become overwhelmed by uncorrected hardware noise.

Optimization problems frequently arise in physics, mathematics, and computer science. The problem of finding the ground state of a given Hamiltonian is one such problem that can be cast as an optimization task. VQAs can utilize noisy quantum computers in tandem with classical optimization loops to address these problems and achieve near-term quantum advantage. For example, VQAs can be used to efficiently find the ground state of a Hamiltonian or to execute diffusion quantum Monte Carlo simulations.

Various operations can be applied to the qubits during these algorithms. For example, specific quantum gates trigger physical rotations around certain axes (e.g., RY gates for rotating a qubit's state vector).

Following gate execution, physical measurements can be performed on the qubits. These measurements provide information about the current state's proximity to the target ground state, determining how effectively the system is evolving toward the desired solution.

Based on these measurements and the classical cost function, the classical computer can solve for updated parameters and apply those updates to the quantum gates for the next circuit run. In this way, the guess for finding the ground state (e.g., the lowest energy state) can be iteratively refined. This feedback loop is repeated, allowing the hybrid system to gradually converge to the ground state.

According to certain embodiments, the classical computer can utilize an artificial intelligence (AI) model (e.g., a neural network) to solve for the updated parameters of the quantum circuit.

The classical computer can determine whether the system has converged to the desired state. If convergence is not reached, the process repeats, e.g., the quantum circuit is updated with a new set of parameters (e.g., updated theta values), and the circuit is executed again. The process iterates until convergence is achieved, generating a final output result.

This final result (e.g., the calculated ground state of a quantum system) is highly valuable for simulations across various fields, including quantum chemistry, material science, physics, and cryptography. For instance, successfully calculating the ground state of a molecule provides insights into its electronic structure, bond energies, and reaction mechanisms, which can be used for drug discovery and material design.

However, in NISQ devices, this final result is often unreliable due to the physical noise present in the system. Addressing this noise to prevent computational errors often uses mitigation techniques that have historically been exceedingly time consuming, resource intensive, or mathematically biased.

Removing or mitigating noise remains a considerable challenge in quantum computation. While full quantum error-correction schemes can theoretically detect and correct noise, they require complex encoding and decoding protocols. To deliver meaningful results, these fault-tolerant schemes necessitate thousands to millions of physical qubits, placing them beyond the reach of current NISQ hardware capabilities.

Instead of full error correction, various types of quantum error mitigation (QEM) can be applied to improve the measurement outcome of the expectation value, such as zero-noise extrapolation (ZNE) and probabilistic error cancellation (PEC).

When evaluating different error mitigation protocols, three primary performance metrics can be examined, such as the number of ancilla qubits required, the amount of bias present in the final estimate, and the sampling overhead required to achieve the result. Sampling overhead is closely related to statistical variance. Bias and variance can be defined as shown in Equation 1 and Equation 2, respectively.

Bias=E[Ô]−Tr[Oρ] [Equation 1]

Var=E[Ô²]−E[Ô] [Equation 2]

Engineering a practical error mitigation protocol calls for navigating the bias-variance tradeoff, e.g., finding a practical balance between the algorithm's accuracy (bias) and its statistical stability (variance). Protocols that introduce high bias may miss important computational details, while protocols with high variance require an impractical number of hardware sampling shots to achieve a reliable average. A practical mitigation algorithm should find a middle ground that minimizes computational sampling intensity while providing sufficiently accurate results.

Standard zero-noise extrapolation (ZNE) operates by systematically amplifying the noise present in a quantum computer in a controlled manner, taking measurements at those elevated noise levels, and then mathematically extrapolating the results back to a theoretical zero-noise limit.

For instance, standard ZNE includes running the same quantum circuit many times with varying noise amplification factors, measuring the outcomes, and fitting a curve to the data that relates the noise level to the measured expectation values. By extrapolating this curve backwards to the y-intercept (where noise equals zero), the ideal noise-free outcome can be estimated.

However, standard ZNE relies on heuristic guessing to fit the extrapolation curve. Because standard ZNE lacks a theoretical physical foundation for the shape of the decay curve, it relies on arbitrary polynomial, linear, or empirical exponential fits. As a result, the backward extrapolation suffers from a massive confidence interval, producing statistically unstable estimates with very high variance.

Conversely, theoretical Probabilistic Error Cancellation (PEC) is designed to produce unbiased results by leveraging a mathematical model of the hardware noise to probabilistically inject inverse operations.

In PEC, a noisy unitary gate is mathematically decomposed into a quasi-probabilistic linear combination of a discrete set of implementable basis gates. The quantum computer executes the circuit by randomly sampling and inserting the implementable gates according to the calculated distribution.

However, because these theoretical decompositions inevitably contain negative coefficients (e.g., the “sign problem”), tracking the parity signs during theoretical PEC causes the statistical variance to explode. Consequently, theoretical PEC requires exponential sampling overhead and exponential runtime to achieve a reliable average, quickly destroying any quantum advantage as the depth of the quantum circuit increases.

To address these issues, embodiments of the present disclosure provide a method for mitigating errors and certifying hardware using a physics-inspired extrapolation (PIE) based on an Error Mitigation by Restricted Evolution (EMRE) framework. Rather than guessing an extrapolation curve or suffering the exponential overhead of negative sampling coefficients, the disclosed embodiments derive a deterministic exponential decay function from first physical principles, allowing for a highly stable log-linear extrapolation to zero-noise while simultaneously extracting a hardware certification metric.

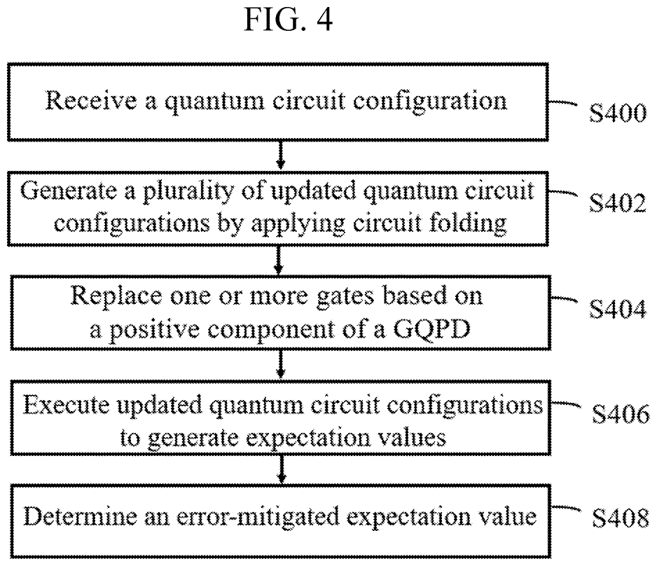

FIG. 4 shows an example flow chart of a method for mitigating error in a quantum computing device according to an embodiment of the present disclosure.

Referring to FIG. 4, in step S400, the quantum computing device (or a classical processor associated with a hybrid quantum-classical architecture, such as the AI device 100 or AI server 200) can receive a quantum circuit configuration. The received quantum circuit configuration can include a plurality of quantum gates configured to execute a specific algorithm, such as a variational quantum algorithm (VQA) for determining a ground state of a molecule. The received quantum circuit configuration can represent an ideal or target logical circuit.

In step S402, the AI device 100 can generate a plurality of updated quantum circuit configurations by applying different numbers of circuit foldings to the quantum circuit configuration. Circuit folding is a technique to systematically and controllably scale the physical noise present in the circuit without altering the logical outcome of the target quantum circuit.

For example, applying circuit folding can include substituting at least one logical gate (e.g., a unitary gate U) of the target quantum circuit with an identity-equivalent gate sequence (e.g., U→UU^{†}U). By varying the number of foldings (e.g., applying a noise scale factor of G=1, 3, 5, etc.), the AI device 100 can generate a plurality of circuits that represent the same physical operation but accumulate progressively higher levels of hardware noise.

In step S404, the AI device 100 replaces one or more gates in the plurality of updated quantum circuit configurations based on a positive component of a generalized quasi-probabilistic decomposition (GQPD).

For instance, to implement error mitigation by restricted evolution (EMRE) and avoid exponential sampling overhead, a target gate (or the folded gate sequences) is mathematically decomposed into a GQPD including a positive probability component and a negative probability component.

Further in this example, the AI device 100 can replace the target gate with at least one implementable quantum gate selected from among a set of implementable quantum gates corresponding to the positive component, while explicitly excluding the negative component of the GQPD. Excluding the negative component can prevent the statistical variance from exploding, thereby avoiding the exponential runtime associated with theoretical probabilistic error cancellation (PEC).

In step S406, the AI device 100 can execute the plurality of updated quantum circuit configurations to generate a plurality of experimental expectation values. For example, the quantum processing unit (QPU) executes the generated circuits corresponding to the different numbers of circuit foldings. Because each updated circuit has a different noise scale factor, the resulting physical measurements yield a set of noisy expectation values corresponding to the different levels of amplified noise.

In step S408, the AI device 100 can determine an error-mitigated expectation value based on the executed results. According to an embodiment, the device calculates the error-mitigated expectation value by applying a linear extrapolation between a logarithm of the plurality of experimental expectation values and the corresponding different numbers of circuit foldings.

Because the EMRE framework provides for the hardware noise to decay according to a mathematically derived exponential function (rather than an arbitrary or heuristic polynomial curve), calculating the logarithm of the noisy expectation values allows the device to perform a highly stable linear fit.

Further, by extrapolating this log-linear fit back to a zero-noise limit (e.g., a state where the circuit folding scale factor is zero), the device can accurately output the error-mitigated expectation value with exponentially reduced statistical variance compared to standard zero-noise extrapolation methods. Various aspects of the method are discussed in more detail below, according to embodiments.

To further illustrate the physics-inspired extrapolation (PIE) and error mitigation by restricted evolution (EMRE) framework, the following section details an example workflow of the method applied to a target quantum circuit, denoted as ideal circuit U, according to an embodiment.

A main goal of quantum error mitigation is to output an accurate estimate of the expectation value of an observable given a noisy hardware environment. In a physical quantum computing environment, it is difficult to execute the ideal circuit U perfectly. Instead, the hardware executes an erroneous circuit, which can be mathematically modeled as the ideal circuit U followed by a physical noise channel E.

In related approaches, mitigating this noise either requires resource intensive noise characterization (to find the exact mathematical inverse of E) or relies on arbitrarily chosen extrapolation functions that lack a solid theoretical foundation. The present disclosure can resolve both challenges by deriving a deterministic extrapolation fit from first physical principles without requiring any prior knowledge of the underlying noise E.

According to an embodiment, the method can include obtaining expectation values of an observable for different circuit foldings. For example, suppose the target quantum circuit is represented by U, the AI device 100 (or the hybrid quantum-classical system) computes the expectation value of a physical observable [symbol] to [symbol] [symbol] [symbol] =Tr[ [symbol] U(ψ)] using a quantum computer, where ψ is an initial state.

Next, the system can repeat the execution process by folding the circuit. Upon folding the circuit once, the new physical circuit becomes U∘U^{†}∘U. Logically and ideally, this sequence is mathematically equal to U, but in the presence of physical hardware noise, the newly folded circuit amplifies the noise. The system then computes a new experimental expectation value of the observable [symbol] given this newly folded, noisier circuit.

The system similarly proceeds by folding the circuit again and computing the expectation value of the observable for each sequential iteration. Accordingly, for each folding number n=0, 1, 2, . . . , the system acquires a corresponding noisy expectation value.

Further in this example, the method can include finding the right extrapolation fit. Until now, related zero-noise extrapolation (ZNE) techniques would just choose an extrapolation fit randomly or heuristically (e.g., arbitrarily guessing a polynomial or exponential curve). In contrast, the present disclosure can derive the exact extrapolation fit from first principles.

For instance, using EMRE, the ideal circuit U can be approximated as U≈SE∘U, where s is the generalized robustness and E denotes the noise. In practice, the system neither knows s nor E. However, using this EMRE relationship and the circuit folding data, the system can construct a highly stable mathematical model. Using this and folding can produce Equation 3 below.

$$\text{?} 𝒪 {\text{?}}_{𝒰} = \text{?} 𝒪 {\text{?}}_{𝒰 ∘ {( {𝒰}^{†} ∘ 𝒰 )}^{n}} \approx {s}^{( 2 n + 1 )} \text{?} 𝒪 {\text{?}}_{ε ∘ 𝒰 ∘ {( ε ∘ {𝒰}^{†} ∘ ε ∘ 𝒰 )}^{n}} \qquad [ Equation 3 ]$$

Further, Equation 3 can be rearranged to give the following Equation 4, below.

$${〈 𝒪 〉}_{e r r} \approx \frac{{〈 𝒪 〉}_{ideal}}{{s}^{2 n + 1}} \qquad [ Equation 4 ]$$

Denoting a noise scale factor λ=2n+1 (which corresponds to the scaling variable G described in earlier examples), the system can express the erroneous expectation values as an exponential function ƒ of the noise scale factor λ, as shown in Equation 5 below.

ƒ(λ)= [symbol] [symbol] [symbol] _{ideal}s^{-λ} [Equation 5]

By taking the logarithm on both sides of this exponential function, the relationship yields a strictly linear equation, as shown in Equation 6 below.

log(ƒ)=log( [symbol] [symbol] [symbol] _{ideal})−λ log(s) [Equation 6]

Therefore, if the AI device 100 plots the logarithm of the erroneous expectation values on the y-axis and the noise scale factor σ on the x-axis, the system can apply a linear fit and extrapolate the plot backwards to λ→0, which mathematically represents the noiseless, ideal case.

Further still in this example, the method can include estimating the final expectation value and certifying the hardware. After extrapolating the linear fit backwards to the y-intercept, the resulting value is log(ƒ(0)). From this value, the AI device 100 can calculate ƒ(0) (e.g., by calculating the exponential), which outputs the final, highly accurate estimate of the error-mitigated expectation value.

Notably, because the extrapolation fit was derived from first principles, the AI device 100 can also determine the exact physical interpretation of the other parameter in the fit, which is the slope. In the PIE EMRE method, the slope of the linear fit can be exactly log(s), which corresponds to the logarithm of the generalized robustness. Physically, this parameter corresponds to the maximum relative entropy (or distance) between the noisy quantum circuit and the ideal quantum circuit.

Because the slope has a direct, operational meaning, this metric simultaneously leads to hardware certification. For example, it is a means to tell if a user can reliably trust the results from a particular quantum hardware device. Because the slope is equal to the max-relative entropy, the flatter the linear fit, the better the physical hardware is performing, and the more the system can rely on the computed results.

Thus, the PIE EMRE method can achieve highly accurate error mitigation and quantitative hardware certification simultaneously without requiring any additional computational overhead.

While certain example embodiments describe generating the updated quantum circuit configurations by replacing a target gate with at least one implementable quantum gate, the present disclosure is not limited thereto. In alternative embodiments, the generalized quasi-probabilistic decomposition can be applied to the target gate or a folded identity-equivalent gate sequence in various configurations.

For instance, rather than direct replacement, the corresponding implementable quantum gate (e.g., sampled from the positive component) can be inserted immediately prior to the target gate or folded gate sequence as a pre-mitigation step, or inserted immediately subsequent to the target gate or folded gate sequence as a post-mitigation step.

Furthermore, the generalized quasi-probabilistic decomposition can be symmetrically or asymmetrically split to frame the target operation. In such embodiments, a first portion of the sampled implementable quantum gate is inserted prior to the target gate or the folded gate sequence, and a second portion is inserted subsequent to the target gate or the folded gate sequence.

For example, by sandwiching the noisy target gate or the folded identity-equivalent gate sequence, the quantum computing device can more effectively mitigate complex, time-dependent noise operations. Additionally, the decomposition and application of these implementable gates can be applied broadly to multi-gate unitary blocks or entire algorithmic sub-routines within the quantum circuit configuration, rather than being restricted solely to single, discrete logical gates.

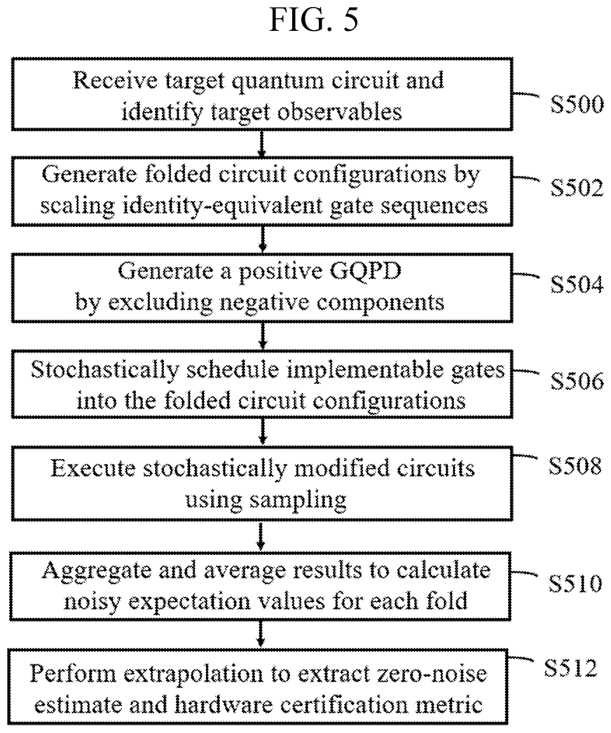

FIG. 5 is a detailed flowchart illustrating an example implementation of the physics-inspired extrapolation (PIE) error mitigation by restricted evolution (EMRE) method, according to an embodiment of the present disclosure.

Referring to FIG. 5, in step S500, the AI device 100 (or the classical processor of a hybrid quantum-classical architecture) can receive a target quantum circuit and identify target observables. This step can include parsing a high-level quantum algorithm (such as a variational quantum algorithm or a quantum chemistry simulation) into a set of discrete quantum gates. The device can also identify the specific physical properties or operators (observables) to be measured at the conclusion of the circuit execution.

In step S502, the AI device 100 can generate folded circuit configurations by scaling identity-equivalent gate sequences. For example, the system can logically amplify the noise by replacing target unitary operations with mathematically equivalent but physically longer sequences.

For example, a target gate U can be replaced by the sequence U∘U^{†}∘U. By iteratively applying different scale factors or folding numbers, the AI device 100 can generate a spectrum of circuit configurations that logically represent the same operation but systematically accumulate different levels of hardware noise.

In step S504, the AI device 100 can generate a positive generalized quasi-probabilistic decomposition (GQPD) by excluding negative components. For example, to prevent the statistical variance from growing exponentially, the system can decompose the error mitigation operations into a set of physically implementable gates (e.g., noisy native Pauli gates) but strictly drops the negative probability components. This isolation yields a strictly-positive probability distribution, ensuring that the subsequent sampling process remains highly efficient. However, embodiments are not limited thereto.

For example, the present disclosure is not limited to strictly excluding all negative components. In an alternative embodiment, the AI device 100 can generate a generalized quasi-probabilistic decomposition that selectively retains a subset of the negative components to purposefully increase the accuracy of the error mitigation at the expense of additional computational overhead.

By incorporating a limited number of the most mathematically impactful negative probability components (e.g., retaining only those negative coefficients having an absolute value above a predefined threshold, or retaining a top percentile of negative components), the system can further reduce mathematical bias in the final expectation value. While this approach necessitates tracking negative parity signs during the stochastic execution and consequently increases the statistical variance, limiting the inclusion to only a few negative components allows the system to achieve higher physical fidelity without incurring the full exponential sampling overhead associated with theoretical probabilistic error cancellation.

Thus, the AI device 100 can dynamically navigate the bias-variance tradeoff, tuning the balance between target accuracy and computational runtime based on specific user requirements or available hardware resources.

In step S506, the AI device 100 stochastically schedules the implementable gates into the folded circuit configurations. Using the positive probability distribution calculated in step S504, a circuit scheduler dynamically samples and inserts the implementable quantum gates into the folded circuits. For instance, a sampled Pauli gate can be logically inserted immediately prior to, or subsequent to, the execution of the target folded gate sequence to inject the restricted evolution properties.

In step S508, the quantum computing device executes the stochastically modified circuits using sampling. Because the inserted mitigating gates are probabilistically selected, the quantum hardware executes the updated circuit configurations over a plurality of iterations, e.g., using Monte Carlo sampling. Each discrete run can feature a different random arrangement of the implementable gates dictated by the positive GQPD.

In step S510, the AI device 100 can aggregate and average the measurement results to calculate noisy expectation values for each fold. The classical processor can collect the measurement readouts from the multiple quantum hardware runs and compute a statistical average.

Also, according to an embodiment, because the negative components were excluded during the GQPD generation, this averaging converges quickly. The process outputs a distinct, mathematically stable noisy expectation value corresponding to each respective circuit folding scale factor.

In step S512, the AI device 100 can perform an extrapolation to extract the zero-noise estimate and a hardware certification metric. By plotting the logarithm of the averaged noisy expectation values against the corresponding noise scale factors, the AI device 100 calculates a deterministic linear fit.

For example, extrapolating this line backwards to the y-intercept outputs the highly accurate, error-mitigated zero-noise expectation value. Concurrently, the AI device 100 can extract the slope of this log-linear fit to output the maximum relative entropy, serving as a quantitative hardware certification metric that indicates the operational fidelity of the quantum device.

While the stochastic scheduling and execution described in step S508 can utilize standard Monte Carlo sampling, the present disclosure is not limited thereto. In alternative embodiments, the system can employ quasi-Monte Carlo sampling, stratified sampling, or importance sampling to dynamically select the implementable quantum gates from the strictly-positive probability distribution. These advanced sampling techniques can further accelerate the convergence of the expectation value by ensuring a more uniform distribution of the inserted physical operations across the plurality of hardware shots.

As used herein, the term “implementable quantum gate” can refer to a natively executable physical operation, or a predefined physical sequence of natively executable operations, that the hardware of the quantum computing device is physically configured to perform. Because quantum hardware modalities (such as superconducting transmons, trapped ions, or neutral atoms) possess limited sets of physical control mechanisms (e.g., specific microwave pulses or laser arrays), theoretical quantum operations often cannot be executed directly. Therefore, an implementable quantum gate can be an operation selected from a limited hardware-specific basis gate set that can be applied to the physical qubits with high fidelity. By way of example and not limitation, an implementable quantum gate can include single-qubit native hardware gates, two-qubit native entangling gates (e.g., a controlled-NOT (CNOT) gate, a controlled-Z (CZ) gate, or an iSWAP gate), or Pauli gates (e.g., Pauli-X, Pauli-Y, Pauli-Z, and the Identity gate) which can be heavily utilized as basis states during the generalized quasi-probabilistic decomposition.

In addition, the highly accurate, error-mitigated zero-noise expectation value generated in step S512 can serve as an important building block for a variety of downstream hybrid quantum-classical algorithms.

For example, in many practical near-term quantum computing applications, the quantum hardware is utilized as a specialized co-processor to measure a physical observable or evaluate a cost function, while a classical optimizer iteratively updates the circuit parameters based on that evaluation. Because the physics-inspired extrapolation (PIE) technique provides a high-fidelity expectation value while bypassing exponential sampling overhead, these hybrid algorithms can converge more rapidly and prevent the algorithm from stalling or getting stuck due to hardware noise.

According to an embodiment, the mitigated expectation value can be utilized in quantum chemistry and materials science downstream tasks, such as executing a Variational Quantum Eigensolver (VQE) algorithm. In a VQE application, the expectation value represents the energy state of a molecular Hamiltonian. By utilizing the PIE EMRE method to highly accurately estimate the ground state energy of complex molecular structures, a classical computing system can simulate physical and chemical properties that are fundamentally intractable for classical supercomputers.

According to another embodiment, the mitigated expectation value can be utilized in complex combinatorial optimization tasks or quantum machine learning (QML) applications.

For example, when employing the Quantum Approximate Optimization Algorithm (QAOA) for large scale network design, the expectation value corresponds to the cost function of the optimization problem. These optimization algorithms can be specifically applied to solving complex parameter landscapes for advanced display technologies, such as optimizing subpixel circuits, encapsulation layers, and display drivers for OLED, Micro LED, and flexible display panels.

Additionally, in QML environments, the mitigated expectation value can be utilized as a precise gradient or loss metric fed into a classical neural network training loop. By ensuring the gradient estimations are highly accurate and largely free from unmitigated hardware noise, the AI device 100 can reliably accelerate the training and fine-tuning of generative AI modules or other complex language model architectures.

Furthermore, in related error mitigation techniques, extensive physical protocols such as gate set tomography (GST), randomized benchmarking (RB), interleaved randomized benchmarking (IRB), or quantum process tomography (QPT) are used to extract a measured noise representation prior to mitigation. However, an advantage of the disclosed PIE method is that it can entirely bypass the need for these resource intensive noise characterization protocols. By utilizing programmable circuit folding to systematically scale the noise, the system determines the deterministic log-linear extrapolation fit without requiring any prior characterization or mathematical isolation of the physical hardware's underlying noise channels.

In some embodiments, the AI device 100 can utilize a trained machine learning model to further optimize the execution of the PIE method. For example, the AI device 100 can continuously collect historical calibration data, temperature fluctuations, and cross-talk metrics from the quantum computing device. A neural network or regression model executing on the controller of the AI device can ingest this historical data to dynamically predict the optimal target gates for circuit folding, or to refine the extraction of the hardware certification metric (e.g., the max-relative entropy parameter) based on real-time hardware conditions.

Also, the controller of the AI device 100 can be implemented across various levels of a classical-quantum computing stack. In one embodiment, the AI device 100 can operate as a remote cloud-based server that receives the circuit specification, compiles the updated folded quantum circuit configurations, and transmits them over a network to a distinct quantum hardware provider.

In an alternative embodiment, the AI device 100 and its controller can be tightly integrated into the local control electronics of the quantum computing device itself, such as being embodied within a Field Programmable Gate Array (FPGA), an Application-Specific Integrated Circuit (ASIC), or an Arbitrary Waveform Generator (AWG) that directly orchestrates the analog microwave or laser pulses applied to the physical qubits.

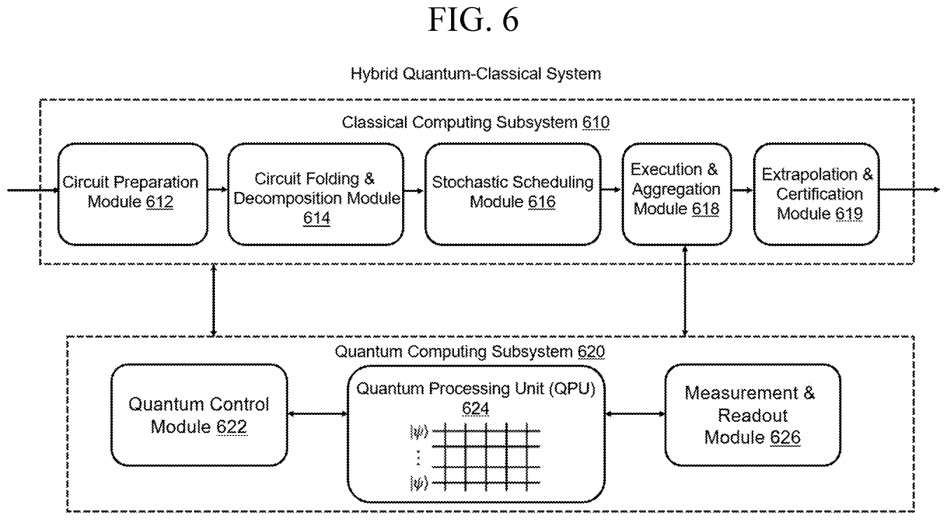

FIG. 6 illustrates a block diagram of a hybrid quantum-classical system for inverse EMRE error mitigation, according to an embodiment of the present disclosure.

Referring to FIG. 6, the overall system can include a Classical Computing Subsystem 610 and a Quantum Computing Subsystem 620, which are bidirectionally connected for system control and data flow.

The Classical Computing Subsystem 610 can be configured to perform the algorithmic, mathematical, and scheduling operations of the error mitigation process (e.g., steps S500-S508 of FIG. 5).

The Quantum Computing Subsystem 620 can be configured to execute the compiled quantum circuits, and the variance-controlled execution of the stochastically modified circuits (e.g., step S510 of FIG. 5).

According to an embodiment, the AI device 100 can include all components of the hybrid quantum-classical system integrated within a single physical unit or local environment. However, embodiments of the present disclosure are not limited thereto. In various embodiments, one or more components of the system can be implemented locally, while other components can be located remotely and accessed via a communication network.

For example, the functional modules of the Classical Computing Subsystem 610 can be executed on a local user workstation or a distributed cloud server, while the physical hardware of the Quantum Computing Subsystem 620 can be housed in a separate, specialized facility and accessed remotely over a wired or wireless network to execute the compiled quantum circuits.

Further in this example, the Classical Computing Subsystem 610 contains several interconnected functional modules. A Circuit Preparation Module 612 receives the unmitigated circuit input, parses the circuit logic, and identifies the multi-qubit gates targeted for error mitigation (e.g., performing step S500 of FIG. 5).

A Noise Characterization & Inversion Module 614 can bidirectionally interface with the Quantum Computing Subsystem 620. The Noise Characterization & Inversion Module 614 can be configured to trigger the tomographic characterization sequences on the hardware, retrieve the resulting raw noisy data, and classically compute the isolated inverse noise representations for each target gate location (e.g., performing steps S502 and S504 of FIG. 5).

A Stochastic Scheduling Module 616 can receive the inverse noise representations. For example, the Stochastic Scheduling Module 616 can be configured to generate the generalized quasi-probabilistic decompositions, discard the negative probability components to form strictly-positive probability distributions, and classically roll digital dice (Monte Carlo sampling) to compile the thousands of uniquely modified circuit configurations (e.g., performing steps S506 and S508 of FIG. 5).

In addition, an Execution & Aggregation Module 618 can receive the stochastically scheduled circuit configurations. The Execution & Aggregation Module 618 can be configured to manage the deployment of these configurations to the Quantum Computing Subsystem 620 for execution, receive the resulting measurement outcomes from the hardware, and aggregate them to compute and output the final, error-mitigated expectation value (e.g., managing step S510 and performing step S512 of FIG. 5).

The Quantum Computing Subsystem 620 can include physical hardware components and associated control electronics. A Quantum Control Module 622 can receive digital control signals and compiled circuit configurations from the classical subsystem, translate them into precise physical control pulses (e.g., microwave or RF signals), and bidirectionally connects to the QPU 624.

Also, the Quantum Processing Unit (QPU) 624 houses the physical qubits (e.g., superconducting transmons) and executes the physical quantum operations as driven by the control signals.

Further, a Measurement & Readout Module 626 can connect bidirectionally to the QPU 624. At the conclusion of a circuit iteration, the Measurement & Readout Module 626 can probe the qubits to collapse their states, digitize the physical signals, and transmit the resulting raw measurement outcomes (classical bit strings) back to the Execution & Aggregation Module 618 in the classical subsystem.

In some embodiments, the inverse EMRE protocol can be executed as part of a multi-layered hybrid mitigation pipeline. For instance, after the Execution & Aggregation Module 618 receives the raw measurement outcomes (e.g., classical bit strings) from the Measurement & Readout Module 626, the system can apply a classical Readout Error Mitigation (REM) matrix to the outcomes prior to or during the averaging step. This combined approach can simultaneously neutralize both the in-circuit operational noise via restricted evolution and the backend measurement readout errors.

FIG. 6 illustrates a block diagram of a hybrid quantum-classical system for executing physics-inspired extrapolation (PIE) and error mitigation by restricted evolution (EMRE), according to an embodiment of the present disclosure.

Referring to FIG. 6, the overall system can include a Classical Computing Subsystem 610 and a Quantum Computing Subsystem 620, which are bidirectionally connected for system control and data flow.

The Classical Computing Subsystem 610 can be configured to perform the algorithmic, mathematical, scheduling, and extrapolation operations of the error mitigation process (e.g., steps S500-S506 and S510-S512 of FIG. 5).

The Quantum Computing Subsystem 620 can be configured to execute the compiled quantum circuits, and the variance-controlled execution of the stochastically modified circuits (e.g., step S508 of FIG. 5).

According to an embodiment, the AI device 100 can include all components of the hybrid quantum-classical system integrated within a single physical unit or local environment. However, embodiments of the present disclosure are not limited thereto. In various embodiments, one or more components of the system can be implemented locally, while other components can be located remotely and accessed via a communication network.

For example, the functional modules of the Classical Computing Subsystem 610 can be executed on a local user workstation or a distributed cloud server, while the physical hardware of the Quantum Computing Subsystem 620 can be housed in a separate, specialized facility and accessed remotely over a wired or wireless network to execute the compiled quantum circuits.

Further in this example, the Classical Computing Subsystem 610 contains several interconnected functional modules. A Circuit Preparation Module 612 receives the unmitigated target quantum circuit, parses the circuit logic, and identifies the target observables (e.g., performing step S500 of FIG. 5).

Then, a Circuit Folding & Decomposition Module 614 receives the parsed circuit data and can be configured to logically amplify the hardware noise by generating folded circuit configurations comprising identity-equivalent gate sequences. Further, the Circuit Folding & Decomposition Module 614 can calculate the generalized quasi-probabilistic decompositions and isolates the strictly-positive probability components (e.g., performing steps S502 and S504 of FIG. 5).

A Stochastic Scheduling Module 616 can receive the folded configurations and the positive probability components. For example, the Stochastic Scheduling Module 616 can be configured to classically roll digital dice (e.g., utilizing Monte Carlo sampling) to stochastically insert the implementable quantum gates into the folded circuit configurations, compiling thousands of uniquely modified circuits ready for execution (e.g., performing step S506 of FIG. 5).

In addition, an Execution & Aggregation Module 618 can receive the stochastically scheduled circuit configurations. The Execution & Aggregation Module 618 can be configured to manage the deployment of these configurations to the Quantum Computing Subsystem 620 for execution, receive the resulting measurement outcomes from the hardware, and aggregate them to compute a distinct noisy expectation value for each respective circuit folding scale factor (e.g., managing step S508 and performing step S510 of FIG. 5).

An Extrapolation & Certification Module 619 can receive the aggregated noisy expectation values and their corresponding noise scale factors. The Extrapolation & Certification Module 619 can be configured to perform a deterministic log-linear extrapolation based on the EMRE framework to compute and output the final, highly accurate error-mitigated zero-noise estimate.

Concurrently or optionally, the Extrapolation & Certification Module 619 can extract the slope of the extrapolation fit to output the maximum relative entropy parameter as a hardware certification metric (e.g., performing step S512 of FIG. 5).

The Quantum Computing Subsystem 620 can include physical hardware components and associated control electronics. A Quantum Control Module 622 can receive digital control signals and compiled circuit configurations from the classical subsystem, translate them into precise physical control pulses (e.g., microwave or RF signals), and bidirectionally connects to the QPU 624.

Also, the Quantum Processing Unit (QPU) 624 houses the physical qubits (e.g., superconducting transmons) and executes the physical quantum operations as driven by the control signals.

Further, a Measurement & Readout Module 626 can connect bidirectionally to the QPU 624. At the conclusion of a circuit iteration, the Measurement & Readout Module 626 can probe the qubits to collapse their states, digitize the physical signals, and transmit the resulting raw measurement outcomes (classical bit strings) back to the Execution & Aggregation Module 618 in the classical subsystem.

In some embodiments, the PIE EMRE method can be executed as part of a multi-layered hybrid mitigation pipeline. For instance, after the Execution & Aggregation Module 618 receives the raw measurement outcomes (e.g., classical bit strings) from the Measurement & Readout Module 626, the system can apply a classical Readout Error Mitigation (REM) matrix to the outcomes prior to or during the averaging step. This combined approach can simultaneously neutralize both the in-circuit operational noise via the restricted evolution framework and the backend measurement readout errors.

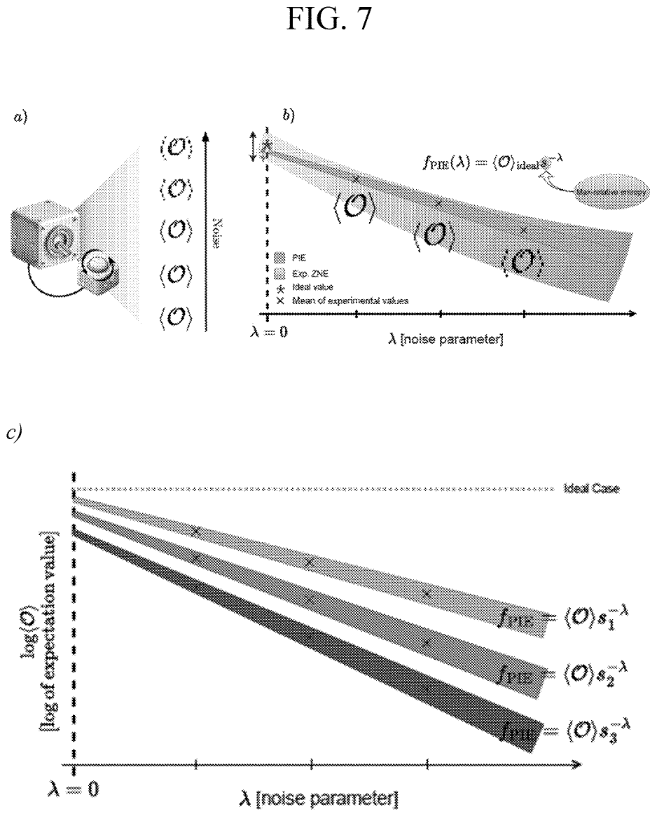

FIG. 7, including parts a), b) and c), illustrates diagrams and data plots representing the physics-inspired extrapolation (PIE) EMRE method, including noise amplification, exponential fitting, and log-linear extrapolation, according to an embodiment of the present disclosure. To mathematically ground the physical execution of the PIE method, the following section details the theoretical proofs that enable the deterministic extrapolation and hardware certification.

For example, a goal of the quantum computing device is to output an accurate estimate of a physical observable. Ideally, the exact expectation value of an observable [symbol] given a target ideal quantum circuit [symbol] applied to an initial state ψ is defined mathematically as: [symbol] [symbol] [symbol] =Tr[ [symbol] U(ψ)].

However, due to the presence of unmitigated physical hardware noise (represented as noise channel ε), the hardware executes an erroneous circuit. Referring to part (a) of FIG. 7, the AI device systematically and logically amplifies this hardware noise. Similar to physically turning a dial to increase noise, the system logically amplifies the noise by applying global circuit folding.

Further, by replacing the ideal target circuit [symbol] with the mathematically equivalent but physically extended sequence [symbol] ∘( [symbol] ^{†}∘ [symbol] )ⁿ, where n is the number of foldings, the physical execution iteratively accumulates more hardware noise ε.

Based on the restricted evolution approximation of the EMRE framework, this sequence mathematically maps the noisy execution to a specific scaling variable. Specifically, the relationship between the ideal expectation value and the folded noisy execution is expressed as:

[symbol]

≈s⁽²ⁿ⁺¹⁾ [symbol] .

From this mapping, the system can establish a direct relationship between the erroneous measured expectation value [symbol] , the ideal expectation value [symbol] [symbol] [symbol] _{ideal}, and the robustness scaling factor s raised to the noise scale factor 2n+1. This can be expressed as:

$${〈 𝒪 〉}_{e r r} \approx \frac{{〈 𝒪 〉}_{ideal}}{{s}^{2 n + 1}} .$$

By substituting the noise scale factor λ=2n+1, the AI device 100 can model the noisy expectation values as an explicit exponential function of λ: ƒ(λ)= [symbol] [symbol] [symbol] _{ideal}s^{-λ}.

Referring to part (b) of FIG. 7, this exponential function is plotted against the noise parameter λ. The graph plots the mean of the experimental values (indicated by “x”) for progressively higher noise levels.

Notably, the PIE EMRE method (illustrated by the inner narrow band) restricts the quantum state evolution strictly to the physically implementable positive components of the generalized quasi-probabilistic decomposition. As shown in part (b), this exclusion of the negative probability components completely suppresses the exponential sampling overhead, resulting in a significantly tighter statistical variance and higher confidence interval than standard exponential Zero-Noise Extrapolation (Exp. ZNE, illustrated by the broader blue band).

Then, to deterministically extract the ideal value (the star * in the upper left part (b) where λ=0), the AI device 100 applies a logarithmic transformation to both sides of the exponential function, yielding a strictly linear equation: log(ƒ)=log( [symbol] [symbol] [symbol] _{ideal})−λ log(s).

Referring to part (c) of FIG. 7, this linear equation allows the AI device 100 to plot the logarithm of the expectation values on the y-axis against the noise parameter λ on the x-axis, resulting in a highly stable linear regression. The AI device 100 extrapolates this linear fit backwards to the y-intercept (λ=0), which outputs the highly accurate, error-mitigated zero-noise expectation value (the “Ideal Case” dotted line).

Furthermore, as illustrated by the distinct extrapolation lines (ƒ_{PIE}) in part (c) corresponding to different scale factors (s₁, s₂, s₃), the slope of the linear fit has a direct physical interpretation. The slope is exactly log(s), which mathematically corresponds to the maximum relative entropy between the noisy physical circuit and the ideal target circuit.

Therefore, without any additional physical probing or computational overhead, the AI device 100 extracts this slope to serve as a quantitative hardware certification metric. A steeper slope (e.g., s₃) indicates higher entropy and worse hardware fidelity, whereas a flatter slope (e.g., s₁) indicates superior hardware resilience, allowing the system to accurately certify the reliability of the underlying quantum processing unit.

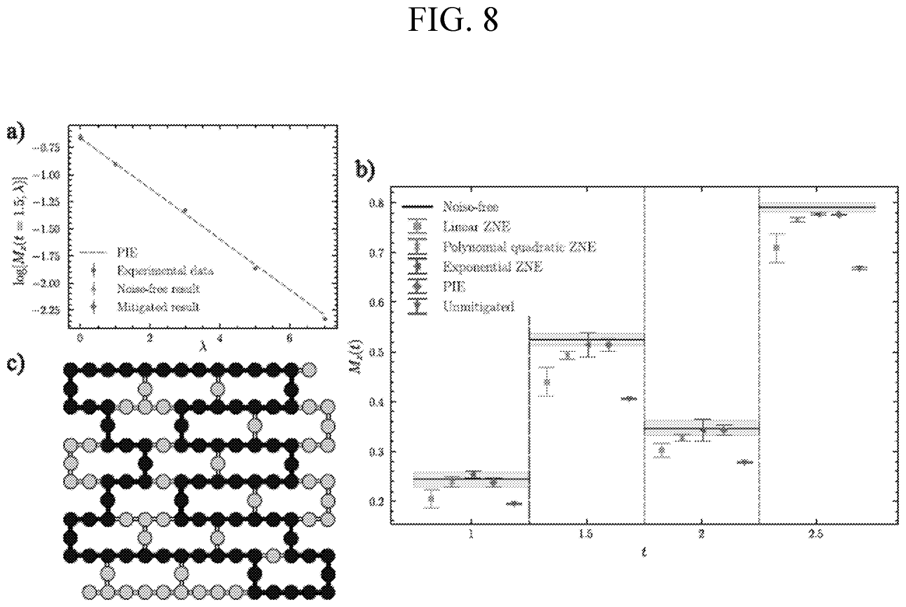

FIG. 8, including parts a), b) and c), illustrates evaluation results comparing the physics-inspired extrapolation (PIE) method against related extrapolation techniques executed on physical quantum hardware, according to an embodiment of the present disclosure. For instance, FIG. 8 demonstrates the application of the PIE method to a complex many-body physics simulation, proving its efficacy on noisy intermediate-scale quantum (NISQ) devices.

Referring to part (c) of FIG. 8, the AI device 100 executed the experimental validation on a heavy-hexagon topology of a superconducting quantum processor (e.g., an IBM Eagle architecture). As illustrated by the dark nodes, a specific subset of physical qubits (e.g., a ring of N=84 qubits) was selected to simulate the dynamics of a one-dimensional Ising chain using Trotter steps. The target observable for the simulation was the global magnetization (M_{z}). The hardware executed the stochastically modified circuit configurations utilizing four distinct extrapolation points and a fixed number of samples (e.g., 4096 shots) per point.

Referring to part (a) of FIG. 8, a log-linear plot demonstrates the deterministic PIE extrapolation for a specific simulation time step (e.g., t=1.5). Due to the deep circuit depth required for 84 qubits, the raw, unmitigated experimental result is heavily degraded by hardware noise, outputting an inaccurate magnetization value of approximately 0.405. However, by taking the logarithm of the noise-amplified expectation values across the four extrapolation points, the AI device establishes a strictly linear relationship. Extrapolating this linear fit backward to the zero-noise limit (λ=0) yields a PIE error-mitigated result of 0.515±0.012. This result is exceptionally accurate.

Referring to part (b) of FIG. 8, a comparison chart illustrates the severe limitations of related Zero-Noise Extrapolation (ZNE) methods compared to the disclosed PIE method across multiple simulation time steps (t=1, 1.5, 2, and 2.5). In standard ZNE, classical processors apply heuristic or arbitrarily chosen curves such as Linear ZNE, Polynomial quadratic ZNE, or standard Exponential ZNE. As shown in the chart, these heuristic methods consistently fail to capture the true physical scaling of the noise. They systematically underestimate or overestimate the target value and often introduce significant mathematical bias.

In stark contrast, the PIE method (illustrated by the diamonds) consistently aligns with the ideal noise-free baseline (illustrated by the horizontal grey bands) across all time steps. Because the PIE log-linear fit is mathematically derived from the first principles of the restricted evolution framework (EMRE), it completely eliminates the arbitrary curve fitting bias inherent to related ZNE techniques.

Furthermore, as shown by the tight error bars in part (b) of FIG. 8, the PIE method achieves these highly accurate results without suffering from the exponential variance associated with Probabilistic Error Cancellation (PEC). By strictly dropping the negative components of the generalized quasi-probabilistic decomposition, the PIE method can ensure that the statistical variance remains tightly controlled, enabling highly reliable, noise-robust estimates on near-term hardware using a minimal, constant number of sampling shots.

According to an embodiment, the AI device 100 can be configured with a hybrid computing framework to achieve highly accurate, error-mitigated quantum measurements by bypassing the statistical variance and noise characterization limitations inherent to near-term quantum hardware. The AI device 100 can be implemented across a wide variety of domains, including, but not limited to, quantum chemistry, materials science, artificial intelligence, and cryptography.

According to one or more embodiments of the present disclosure, the method and hybrid quantum computing framework can solve one or more technological problems in existing quantum computing technology, namely the inability to reliably determine an expectation value of a physical observable without succumbing to exponential computational overhead or relying on physically inaccurate heuristic extrapolation models.

For example, embodiments of the present disclosure can address the combined deficiencies of related art probabilistic error cancellation (PEC) and standard zero-noise extrapolation (ZNE) methods. Standard PEC requires the tracking of negative parity signs during quasi-probabilistic decomposition, leading to an explosion in statistical variance that paralyzes algorithm scaling. Meanwhile, standard ZNE relies on arbitrary mathematical curve-fitting that introduces physical bias. Furthermore, related methods often require resource intensive noise characterization protocols that consume vast amounts of processing resources and hardware uptime.

To overcome these technical deficiencies, the AI device 100 can provide a hardware level solution that drastically reduces processing times and conserves quantum computing resources. By implementing physics-inspired extrapolation (PIE) based on a restricted evolution framework (EMRE), the system can logically amplify noise via circuit folding and mathematically discards negative probability components to utilize strictly positive probability distributions. This elegant physical execution transforms an intractable exponential runtime problem into a scalable, variance-controlled execution. Furthermore, by deriving a deterministic log-linear extrapolation fit, the quantum hardware can reliably determine the expectation value and output a built-in hardware certification metric in near-constant runtime.

Also, according to an embodiment, the AI device 100 configured with the disclosed method can be accessed or utilized via a variety of client terminals and edge devices, including a mobile terminal, a smart device, or an automated robotic system, which can communicate with a quantum computing backend or cloud infrastructure to request specific error-mitigated circuit executions.

The reliable, variance-free expectation values generated by the AI device 100 can be used to execute a wide range of advanced computational applications. For instance, in materials science and quantum chemistry, calculating the ground state for complex molecules provides important insights into their electronic structures, bond energies, and reaction mechanisms. This highly accurate quantum mechanical mapping is useful for developing next-generation physical materials, such as highly efficient fluorescent or phosphorescent compounds utilized in advanced OLED and Micro LED display technologies, or discovering novel superconducting topologies for future computing architectures.

Furthermore, the optimized solutions generated by the classical optimizer utilizing the variance-controlled expectation value can be deployed in advanced graphical or spatial computing domains. For example, the hybrid quantum-classical algorithms can utilize the mitigated results to optimize complex physical routing within advanced display circuits, accelerate the real-time processing pipelines for hyper-realistic digital avatars, or execute high-dimensional matrix operations for complex 3D animation, where classical computing resources are traditionally bottlenecked.

According to another embodiment, the automated laboratory robot or client terminal can utilize the precisely mitigated quantum mechanical properties of a newly synthesized molecule to perform a physical testing or screening action, such as executing complex chemical reactions, performing compound filtering for automated drug discovery, or identifying highly targeted therapeutics without suffering from noise-induced prediction errors.

Furthermore, the disclosed method provides significant advantages for the field of artificial intelligence. The highly accurate, error-mitigated expectation value can be utilized as a precise gradient or cost function metric fed into a classical neural network training loop. By ensuring the gradient estimations are highly accurate, physically unbiased, and free from exponential statistical explosions, the AI device 100 can reliably accelerate the training and fine-tuning of generative artificial intelligence modules, quantum machine learning (QML) models, and complex language model architectures.

In an enterprise or industrial context, the method can be used to develop and deploy specialized autonomous algorithms for chemical manufacturing, automated material discovery, energy storage testing, and decryption. This enables companies to build powerful quantum simulation tools that extract complete, mathematically consistent physical measurements from noisy hardware, while simultaneously certifying the reliability of the hardware itself, thereby streamlining research and development operations and overcoming the fundamental hardware limitations of near-term quantum devices.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for mitigating error in a quantum computing device, the method comprising:
receiving quantum circuit specification data defining a quantum circuit configuration, the quantum circuit configuration specifying a plurality of quantum gates;
generating a plurality of updated quantum circuit configurations by applying different numbers of circuit foldings to the quantum circuit configuration;
modifying the plurality of updated quantum circuit configurations by replacing at least one gate with at least one implementable quantum gate selected from among a set of implementable quantum gates based on a positive component of a generalized quasi-probabilistic decomposition, wherein a negative component of the generalized quasi-probabilistic decomposition is excluded;
transmitting the plurality of updated quantum circuit configurations to the quantum computing device for execution;
receiving a plurality of experimental expectation values from the quantum computing device based on the execution of the plurality of updated quantum circuit configurations, the plurality of experimental expectation values corresponding to the different numbers of circuit foldings; and
determining an error-mitigated expectation value based on applying an extrapolation between the plurality of experimental expectation values and the corresponding different numbers of circuit foldings.

2. The method of claim 1, wherein the determining the error-mitigated expectation value based on applying the extrapolation includes:
calculating the error-mitigated expectation value by applying a linear extrapolation between a logarithm of the plurality of experimental expectation values and the corresponding different numbers of circuit foldings.

3. The method of claim 2, further comprising:
extracting a slope of the linear extrapolation; and
outputting a hardware certification metric based on the slope, wherein the hardware certification metric indicates a maximum relative entropy between a physical implementation of the quantum circuit configuration and an ideal target circuit.

4. The method of claim 1, wherein the applying the different numbers of circuit foldings includes:
substituting at least one logical gate of the quantum circuit configuration with an identity-equivalent gate sequence configured to amplify physical hardware noise without altering a target logical operation of the quantum circuit configuration.

5. The method of claim 1, wherein the modifying the plurality of updated quantum circuit configurations includes:
stochastically inserting the at least one implementable quantum gate into the plurality of updated quantum circuit configurations based on a strictly positive probability distribution derived from the positive component of the generalized quasi-probabilistic decomposition.

6. The method of claim 1, wherein the set of implementable quantum gates includes natively executable Pauli gates.

7. The method of claim 1, further comprising:
retaining a predefined subset of the negative component of the generalized quasi-probabilistic decomposition based on a predefined threshold; and
modifying the plurality of updated quantum circuit configurations further based on the predefined subset of the negative component to dynamically tune a balance between target accuracy and computational variance.

8. The method of claim 1, wherein the generating the plurality of updated quantum circuit configurations and the determining the error-mitigated expectation value are performed without determining a measured noise representation of the quantum computing device via a physical noise characterization protocol.

9. The method of claim 1, further comprising:
predicting, by a trained machine learning model, an optimal target gate location for applying the circuit foldings based on historical calibration data of the quantum computing device.

10. The method of claim 1, wherein the receiving the plurality of experimental expectation values includes:
receiving a plurality of raw measurement outcomes from the quantum computing device generated via Monte Carlo sampling over a plurality of iterations; and
averaging the plurality of raw measurement outcomes to calculate a distinct noisy expectation value corresponding to each respective circuit folding number.

11. The method of claim 1, further comprising:
utilizing the error-mitigated expectation value in a downstream hybrid quantum-classical algorithm to optimize a physical parameter of a device or to evaluate a gradient for training a generative artificial intelligence model.

12. An artificial intelligence (AI) device, comprising:
a memory configured to store a plurality of experimental expectation values; and
a controller configured to:
receive quantum circuit specification data defining a quantum circuit configuration, the quantum circuit configuration specifying a plurality of quantum gates,
generate a plurality of updated quantum circuit configurations by applying different numbers of circuit foldings to the quantum circuit configuration,
modify the plurality of updated quantum circuit configurations by replacing at least one gate with at least one implementable quantum gate selected from among a set of implementable quantum gates based on a positive component of a generalized quasi-probabilistic decomposition, wherein a negative component of the generalized quasi-probabilistic decomposition is excluded,
transmit the plurality of updated quantum circuit configurations to a quantum computing device for execution,
receive the plurality of experimental expectation values from the quantum computing device based on the execution of the plurality of updated quantum circuit configurations, the plurality of experimental expectation values corresponding to the different numbers of circuit foldings, and
determine an error-mitigated expectation value based on applying an extrapolation between the plurality of experimental expectation values and the corresponding different numbers of circuit foldings.

13. The AI device of claim 12, wherein the controller is further configured to:
calculate the error-mitigated expectation value by applying a linear extrapolation between a logarithm of the plurality of experimental expectation values and the corresponding different numbers of circuit foldings.

14. The AI device of claim 13, wherein the controller is further configured to:
extract a slope of the linear extrapolation, and
output a hardware certification metric based on the slope, wherein the hardware certification metric indicates a maximum relative entropy between a physical implementation of the quantum circuit configuration and an ideal target circuit.

15. The AI device of claim 12, wherein the controller is further configured to:
substitute at least one logical gate of the quantum circuit configuration with an identity-equivalent gate sequence configured to amplify physical hardware noise without altering a target logical operation of the quantum circuit configuration.

16. The AI device of claim 12, wherein the controller is further configured to:
stochastically insert the at least one implementable quantum gate into the plurality of updated quantum circuit configurations based on a strictly positive probability distribution derived from the positive component of the generalized quasi-probabilistic decomposition,
wherein the set of implementable quantum gates comprises natively executable Pauli gates.

17. The AI device of claim 12, wherein the controller is further configured to:
retain a predefined subset of the negative component of the generalized quasi-probabilistic decomposition based on a predefined threshold, and
modify the plurality of updated quantum circuit configurations further based on the predefined subset of the negative component to dynamically tune a balance between target accuracy and computational variance.

18. The AI device of claim 12, wherein the controller is configured to generate the plurality of updated quantum circuit configurations and determine the error-mitigated expectation value without determining a measured noise representation of the quantum computing device via a physical noise characterization protocol.

19. The AI device of claim 12, wherein the controller is further configured to:
receive a plurality of raw measurement outcomes from the quantum computing device generated via Monte Carlo sampling over a plurality of iterations, and
average the plurality of raw measurement outcomes to calculate a distinct noisy expectation value corresponding to each respective circuit folding number.

20. A non-transitory computer-readable storage medium storing instructions that, when executed by one or more processors, cause the one or more processors to perform operations comprising:
receiving quantum circuit specification data defining a quantum circuit configuration, the quantum circuit configuration specifying a plurality of quantum gates;
generating a plurality of updated quantum circuit configurations by applying different numbers of circuit foldings to the quantum circuit configuration;
modifying the plurality of updated quantum circuit configurations by replacing at least one gate with at least one implementable quantum gate selected from among a set of implementable quantum gates based on a positive component of a generalized quasi-probabilistic decomposition, wherein a negative component of the generalized quasi-probabilistic decomposition is excluded;
transmitting the plurality of updated quantum circuit configurations to the quantum computing device for execution;
receiving a plurality of experimental expectation values from the quantum computing device based on the execution of the plurality of updated quantum circuit configurations, the plurality of experimental expectation values corresponding to the different numbers of circuit foldings; and
determining an error-mitigated expectation value based on applying an extrapolation between the plurality of experimental expectation values and the corresponding different numbers of circuit foldings.
